(19) United States
(12) Patent Application Publication
(10) Pub. No.: US 2013/0132351 A1
(43) Pub. Date: May 23, 2013

(54) COLLECTION INSPECTOR

(71) Applicant: Kai Richter, Muehltal (DE)

(72) Inventor: Kai Richter, Muehltal (DE)

(73) Assignee: SAP AG

(21) Appl. No.: 13/299,941

(22) Filed: Nov. 18, 2011

(51) Int. Cl. G06F 7/00

(52) U.S. Cl. 707/690; 707/E17.005

(57) ABSTRACT

A computer program product for providing a collection context includes computer-readable instructions embodied on tangible, non-transient media and operable when executed to identifying a collection of items. An indication to inspect one or more items in the collection can be received, and an inspection interface for inspection of the one or more items can be provided, the inspection interface providing at least data about the one or more items and a list of the items in the collection.

### TECHNICAL FIELD

This invention relates to providing collection contexts in inspection applications.

### BACKGROUND

Items, such as user-centric projections of business objects, can be inspected using an interface. The interface can provide a visualization of the item and data regarding the item.

### SUMMARY

Embodiments described in this disclosure include computer-implemented methods, systems, and computer program product for providing a collection context. The computer program product includes computer-readable instructions embodied on tangible, non-transient media, and is operable when executed to identify a collection of items. An indication to inspect one or more items in the collection can be received. An inspection interface can be provided for inspection of the one or more items, the inspection interface providing information pertaining to the one or more items, a list of the items in the collection, and a selectable handle for the collection, the selectable handle for the collection selectable to provide information pertaining to the collection.

In certain implementations of the embodiments, the inspection interface may provide a List Area, that includes a list of the items in the collection. In certain instances, the items in the list of items in the collection may be selectable for inspection. The indication to inspect one or more items in the collection may include receiving a selection of one or more items in the list of items.

In certain implementations of the embodiments, receiving the indication to inspect one or more items in the collection may include receiving an indication to inspect two or more items in the collection. Details of the two or more items can be displayed in the inspection interface. The display of the details of the two or more items may facilitate a comparison of the details of the items.

In certain implementations of the embodiments, the one or more items can include an item corresponding to the collection.

In certain implementations of the embodiments, the list of the items in the collection can provide a context for the inspection of the items.

In certain implementations of the embodiments, the items may include user-centric projections of business objects. The collection may be a collection of user-centric projections of business objects.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an embodiment of a system that provides a context-based inspection of items.

FIG. 2 is an schematic representation of the collection inspector interface.

FIG. 3 is a schematic representation of an example implementation of the collection inspector and a list of items from a search.

FIG. 4A is a schematic representation of an example implementation of the collection inspector showing inspection of a single item.

FIG. 4B is a schematic representation of an example implementation of the collection inspector showing inspection of a multiple items.

FIG. 4C is a schematic representation of an example implementation of the collection inspector showing inspection of the collection.

FIG. 5A is a screen shot of an example implementation of the collection inspector.

FIG. 5B is a screen shot of the example implementation of the collection inspector of FIG. 5A.

FIG. 5C is a screen shot of the example implementation of the collection inspector of FIG. 5A.

FIG. 5D is a screen shot of the example implementation of the collection inspector of FIG. 5A showing the collection in the Details Area.

FIG. 5E a screen shot of the example implementation of the collection inspector of FIG. 5A showing collection refinement functionality in the Details Area.

FIG. 6 is a process flow diagram for providing an inspection of an item in the context of a collection.

Like reference numbers in the various drawings represent like elements.

### DETAILED DESCRIPTION

The collection inspector described in the present application is embodied as a system or computer program product executing a method to inspect items (which are also referred to as “Things”) in the context of a collection. The collection inspector provides a collection context while inspecting the details of a single item or multiple items within the collection. A user is enabled to keep the context of a collection and navigate among items in the collection, while inspecting the item(s). When navigating away from a collection into an item inspector, the user does not have to navigate away from the item to explore the collection. When inspecting an item (e.g., a search, a manually-created collection, a work list, etc.), the user can carry the context over and have it be accessible without additional navigation. Working with an item in the context of a collection is provided without forcing the user to do additional navigation, which may result in a loss of time, efficiency, and/or concentration. The subject matter described herein also allows the user to switch between different collection contexts.

Further, the collection inspector provides a handle (i.e., a way to identify, interact with, inspect, etc.) to the collection itself that is consistent with the visualization of the single item provided by the interface. The user can navigate to a visualization of the collection itself that serves as a handle for the collection and as a location to modify and reuse it. Put another way, users are provided with a handle for the collection that forms the context of the item. This allows the user to work with the single item as well as with the collection itself in a consistent way without further navigation.

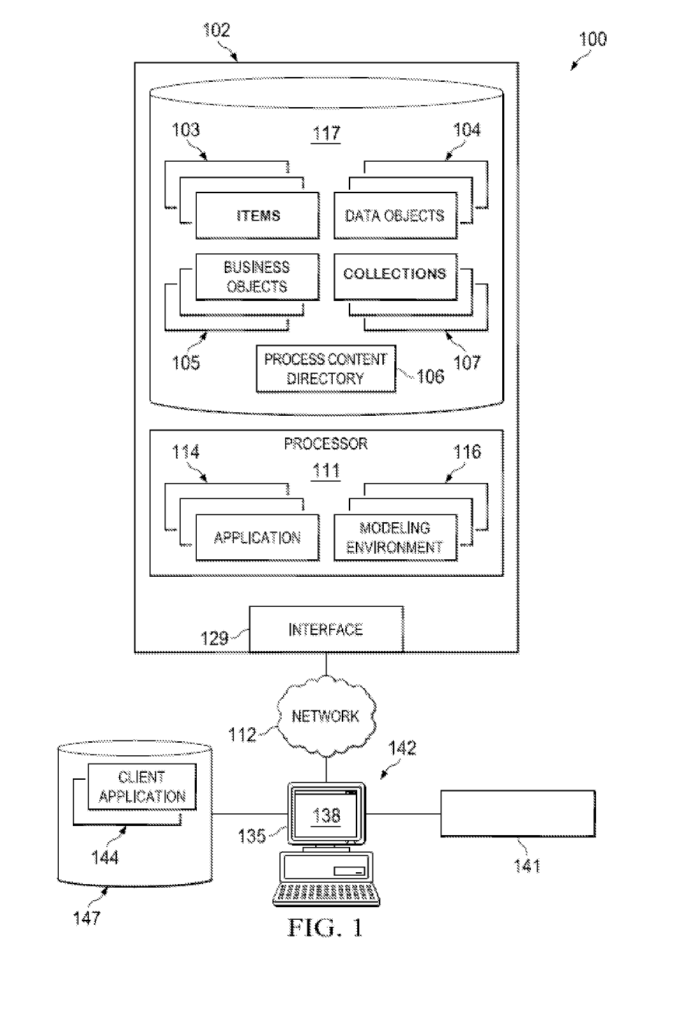

FIG. 1 is a schematic of a system 100 configured for providing an inspection of an item within the context of a collection. The illustrated environment 100 includes, or is communicably coupled with, server 102 and one or more clients 135, at least some of which communicate across network 112. In general, environment 100 depicts an example configuration of a system that provides a collection inspector that facilitates inspection of items (and collections) while also providing the collection context.

In general, the server 102 is any server that stores one or more hosted applications 114, where at least a portion of the hosted applications 114 are executed via requests and responses sent to users or clients 135 within and communicably coupled to the illustrated environment 100 of FIG. 1. Hosted applications 114 include a hosted collection inspector program run on server 102, accessed by client 135, and shown on display 138. In some instances, the server 102 may store a plurality of various hosted applications 114, while in other instances, the server 102 may be a dedicated server meant to store and execute only a single hosted application 114. In some instances, the server 102 may comprise a web server, where the hosted applications 114 represent one or more web-based applications accessed and executed via network 112 by the clients 135 of the system to perform the programmed tasks or operations of the hosted application 114. Hosted application 114 may be a hosted process modeling environment or may be a process execution environment in which processes modeled by client 135 are executed. Hosted application 114 may be a collection inspector interface as described herein. At a high level, the server 102 comprises an electronic computing device operable to receive, transmit, process, store, or manage data and information associated with the environment 100. Specifically, the server 102 illustrated in FIG. 1 is responsible for receiving application requests from one or more client applications 144 associated with the clients 135 of environment 100 and responding to the received requests by processing said requests in the associated hosted application 114, and sending the appropriate response from the hosted application 114 back to the requesting client application 144. Client application 144 may be a collection inspector interface as described herein.

In addition to requests from the external clients 135 illustrated in FIG. 1, requests associated with the hosted applications 114 may also be sent from internal users, external or third-party customers, other automated applications, as well as any other appropriate entities, individuals, systems, or computers. As used in the present disclosure, the term “computer” is intended to encompass any suitable processing device. For example, although FIG. 1 illustrates a single server 102, environment 100 can be implemented using two or more servers 102, as well as computers other than servers, including a server pool. Indeed, server 102 may be any computer or processing device such as, for example, a blade server, general-purpose personal computer (PC), Macintosh®, workstation, UNIX®-based workstation, or any other suitable device. In other words, the present disclosure contemplates computers other than general purpose computers, as well as computers without conventional operating systems. Further, illustrated server 102 may be adapted to execute any operating system, including Linux®, UNIX®, Windows®, Mac OS®, or any other suitable operating system. According to one embodiment, server 102 may also include or be communicably coupled with a mail server.

Generally, the network 112 facilitates wireless or wireline communications between the components of the environment 100 (e.g., between the server 102 and the clients 135), as well as with any other local or remote computer, such as additional clients, servers, or other devices communicably coupled to network 112 but not illustrated in FIG. 1. The network 112 is illustrated as a single network in FIG. 1, but may be a continuous or discontinuous network without departing from the scope of this disclosure, so long as at least a portion of the network 112 may facilitate communications between senders and recipients. The network 112 may be all or a portion of an enterprise or secured network, while in another instance, at least a portion of the network 112 may represent a connection to the Internet. In some instances, a portion of the network 112 may be a virtual private network (VPN), such as, for example, the connection between the client 135 and the server 102. Further, all or a portion of the network 112 can comprise either a wireline or wireless link. Example wireless links may include 802.11a/b/g/n, 802.20, WiMax, and/or any other appropriate wireless link. In other words, the network 112 encompasses any internal or external network, networks, sub-network, or combination thereof operable to facilitate communications between various computing components inside and outside the illustrated environment 100. The network 112 may communicate, for example, Internet Protocol (IP) packets, Frame Relay frames, Asynchronous Transfer Mode (ATM) cells, voice, video, data, and other suitable information between network addresses. The network 112 may also include one or more local area networks (LANs), radio access networks (RANs), metropolitan area networks (MANs), wide area networks (WANs), all or a portion of the Internet, and/or any other communication system or systems at one or more locations.

As shown in FIG. 1, the server 102 includes a processor 111, an interface 129, a memory 117, and one or more hosted applications 114. The interface 129 is used by the server 102 for communicating with other systems in a client-server or other distributed environment (including within environment 100) connected to the network 112 (e.g., client 135, as well as other systems communicably coupled to the network 112). Generally, the interface 129 comprises logic encoded in software and/or hardware in a suitable combination and operable to communicate with the network 112. More specifically, the interface 129 may comprise software supporting one or more communication protocols associated with communications such that the network 112 or interface's hardware is operable to communicate physical signals within and outside the illustrated environment 100.

As illustrated in FIG. 1, server 102 includes a processor 111. Although illustrated as a single processor 111 in FIG. 1, two or more processors may be used according to particular needs, desires, or particular embodiments of environment 100. Each processor 111 may be a central processing unit (CPU), a blade, an application specific integrated circuit (ASIC), a field-programmable gate array (FPGA), or another suitable component. Generally, the processor 111 executes instructions and manipulates data to perform the operations of server 102 and, specifically, the one or more plurality of hosted applications 114. Specifically, the server's processor 111 executes the functionality required to receive and respond to requests from the client(s) 135 and their respective client applications 144, as well as the functionality required to perform the other operations of the hosted applications 114. Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java®, Visual Basic, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, processor 111 executes one or more hosted applications 114 on the server 102.

At a high level, each of the one or more hosted applications 114 is any application, program, module, process, or other software that may execute, change, delete, generate, or otherwise manage information according to the present disclosure, particularly in response to, and in connection with, one or more requests received from the illustrated clients 135 and their associated client applications 144. For example, hosted application 114 may be a collection inspector program hosed on a server 102. The collection inspector provides an inspection interface for process model 103 in the context of a collection (e.g., a collection of the items). A user is enabled to keep the context of a collection and navigate and use it along with inspecting a single item. When navigating away from a collection into the item inspector, the user does not have to navigate back, but can explore the collection next to the visualization item (or the item's details).

Coming from any type of collection of items (e.g., search, manually-created collection, work list, etc.), when inspecting an item, the user can carry the context over and have it accessible at hand without additional navigation. Working with an item in the context of a collection, therefore, is provided without forcing the user to do additional navigation and loss of time. The techniques described herein also allow the user to switch between different collection contexts.

Further, users are provided with a handle for the collection that forms the context of the Thing. This allows the user to work with the single item as well as with the collection in the same and consistent way without navigation. The collection inspector provides a handle to the collection itself that is consistent with the visualization of an item. The user can navigate to an inspector details page of the collection itself that serves as handle for the collection and a place to modify and reuse it. As such, collections and items are managed in a consistent and integrated way.

In certain cases, only one hosted application 114 may be located at a particular server 102. In others, a plurality of related and/or unrelated hosted applications 114 may be stored at a single server 102, or located across a plurality of other servers 102, as well. In certain cases, environment 100 may implement a composite hosted application 114. For example, portions of the composite application may be implemented as Enterprise Java Beans (EJBs) or design-time components may have the ability to generate run-time implementations into different platforms, such as J2EE™ (Java™ 2 Platform, Enterprise Edition), ABAP (Advanced Business Application Programming) objects, or Microsoft's .NET®, among others. Additionally, the hosted applications 114 may represent web-based applications accessed and executed by remote clients 135 or client applications 144 via the network 112 (e.g., through the Internet). Further, while illustrated as internal to server 102, one or more processes associated with a particular hosted application 114 may be stored, referenced, or executed remotely. For example, a portion of a particular hosted application 114 may be a web service associated with the application that is remotely called, while another portion of the hosted application 114 may be an interface object or agent bundled for processing at a remote client 135. Moreover, any or all of the hosted applications 114 may be a child or sub-module of another software module or enterprise application (not illustrated) without departing from the scope of this disclosure. Still further, portions of the hosted application 114 may be executed by a user working directly at server 102, as well as remotely at client 135.

Each business object 105 is a capsule with an internal hierarchical structure, behavior offered by its operations, and integrity constraints. Business objects 105 are generally semantically disjointed, i.e., the same business information is represented once. In some embodiments, the business objects 105 are arranged in an ordering framework such that they can be arranged according to their existence dependency to each other. For example, in a modeling environment, the customizing elements might be arranged on the left side of the process model 103, the strategic elements might be arranged in the center of the process model 103, and the operative elements might be arranged on the right side of the process model 103. Similarly, the business objects 105 can be arranged in this model from the top to the bottom based on defined order of the business areas, e.g., finance could be arranged at the top of the business object model with customer relationship management (CRM) below finance, and supplier relationship management (SRM) below CRM. To help ensure the consistency of interfaces, the business object model may be built using standardized data types, as well as packages, to group related elements together, and package templates and entity templates to specify the arrangement of packages and entities within the structure.

A business object may be defined such that it contains multiple layers, such as in the example business object 105. The example business object 105 contains four layers: the kernel layer, the integrity layer, the interface layer, and the access layer. The innermost layer of the example business object 105 is the kernel layer. The kernel layer represents the business object's 105 inherent data, containing various attributes of the defined business object. The second layer represents the integrity layer. In the example business object 105, the integrity layer contains the business logic of the object. Such logic may include business rules for consistent embedding in the environment 100 and the constraints regarding the values and domains that apply to the business object 105. Business logic may comprise statements that define or constrain some aspect of the business, such that they are intended to assert business structure or to control or influence the behavior of the business entity. It may pertain to the facts recorded on data and constraints on changes to that data. In effect, business logic may determine what data may, or may not, be recorded in business object 105. The third layer, the interface layer, may supply the valid options for accessing the business object 105 and describe the implementation, structure, and interface of the business object 105 to the outside world. To do so, the interface layer may contain methods, input event controls, and output events. The fourth and outermost layer of the business object 105 is in the access layer. The access layer defines the technologies that may be used for external access to the business object's data. Some examples of allowed technologies may include COM/DCOM (Component Object Model/Distributed Component Object Model), CORBA (Common Object Request Broker Architecture), RFC (Remote Function Call), Hypertext Transfer Protocol (HTTP) and Java™, among others. Additionally, business objects 105 of this embodiment may implement object-oriented technologies such as encapsulation, inheritance, and/or polymorphism.

Some or all of the data objects 105, process models 103, data objects 104, and collections 107 may be stored or referenced in a memory 117, which can be a development or metamodel repository. This memory 117 may include parameters, pointers, variables, algorithms, instructions, rules, files, links, or other data for easily providing information associated with or to facilitate modeling of the particular object. More specifically, each memory 117 may be formatted, stored, or defined as various data structures in eXtensible Markup Language (XML) documents, text files, Virtual Storage Access Method (VSAM) files, flat files, Btrieve files, comma-separated-value (CSV) files, internal variables, one or more libraries, or any other format capable of storing or presenting all or a portion of the interface, process, data, and other models or modeling domains. In short, each repository may comprise one table or file or a plurality of tables or files stored on one computer or across a plurality of computers in any appropriate format as described above. Indeed, some or all of the particular repository may be local or remote without departing from the scope of this disclosure and store any type of appropriate data.

Memory 117 may include any memory or database module and may take the form of volatile or non-volatile memory including, without limitation, magnetic media, optical media, random access memory (RAM), read-only memory (ROM), removable media, or any other suitable local or remote memory component. Memory 117 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 102 and its one or more hosted applications 114. Additionally, memory 117 may include any other appropriate data, such as VPN applications, firmware logs and policies, firewall policies, a security or access log, print or other reporting files, as well as others.

Memory 117, whether local or distributed, can also store a process content directory 106. The process content directory 106 can store detailed relationship and connection information defined between the models and entities designed in the modeling environment 116, as well as provide the data and other information needed to allow for the automated addition of model-related and model-defining information into high-level models created by business users and technical developers. For example, the directory 106 may store detailed information regarding additional and/or more detailed connections defined for the high-level elements created or modeled in the modeling environment 116. The process content directory 106 can store information used to define previously-generated models, including the connections and operations included in and associated with various modeled entities. Therefore, the information stored in the directory 106 can be used for the automatic generation of later-developed or updated models when one or more elements added to a particular model have previously been used or modeled in earlier-defined models. Additionally, changes to one or more of the models associated with the directory 106 can be reflected in the data stored therein. Process models 103 defined or generated using information from the directory 106 can be automatically updated by reloading or re-analyzing the modified information stored within the directories. Memory 117 stores business objects 105, as well as items 103 and data objects 104. Items 103 include user-centric projections of business objects. These projections include the following characteristics: (a) these projections represent work objects from a user perspective irrespective of system-side processes; (b) the amount of information contained in a projection is reduced to the properties and functions that are required by a user in a specific professional role; (c) the information is formatted in a way that is easily consumable by a human being and not optimized for data base storage, transmission or other types of usage; and (d) the projections can represent more than one business object or there might be different projections for the same business object depending on the object's status or the user accessing the information.

The illustrated environment of FIG. 1 also includes one or more clients 135. Each client 135 may be any computing device operable to connect to or communicate with at least the server 102 and/or via the network 112 using a wireline or wireless connection. Further, as illustrated by client 135, each client 135 includes a processor 141, an interface 142, a graphical user interface (GUI) 138, a client application 144, and a memory 147. In general, each client 135 comprises an electronic computer device operable to receive, transmit, process, and store any appropriate data associated with the environment 100 of FIG. 1. It will be understood that there may be any number of clients 135 associated with, or external to, environment 100, even though environment 100 shows a single client. Additionally, there may also be one or more additional clients 135 external to the illustrated portion of environment 100 that are capable of interacting with the environment 100 via the network 112. Further, the term “client” and “user” may be used interchangeably as appropriate without departing from the scope of this disclosure. Moreover, while each client 135 is described in terms of being used by a single user, this disclosure contemplates that many users may use one computer, or that one user may use multiple computers. As used in this disclosure, client 135 is intended to encompass a personal computer, touch screen terminal, workstation, network computer, kiosk, wireless data port, smart phone, personal data assistant (PDA), one or more processors within these or other devices, or any other suitable processing device. For example, each client 135 may comprise a computer that includes an input device, such as a keypad, touch screen, mouse, or other device that can accept user information, and an output device that conveys information associated with the operation of the server 102 (and hosted application 114) or the client 135 itself, including digital data, visual information, the client application 144, or the GUI 138. Both the input and output device may include fixed or removable storage media such as a magnetic storage media, CD-ROM, or other suitable media to both receive input from and provide output to users of the clients 135 through the display, namely, the GUI 138.

Further, the illustrated client 135 includes a GUI 138 comprising a graphical user interface operable to interface with at least a portion of environment 100 for any suitable purpose, including generating a visual representation of the client application 144 (in some instances, the client's web browser) and the interactions with the hosted application 114, including the responses received from the hosted application 114 received in response to the requests sent by the client application 144. Generally, through the GUI 138, the user is provided with an efficient and user-friendly presentation of data provided by or communicated within the system. The term “graphical user interface,” or GUI, may be used in the singular or the plural to describe one or more graphical user interfaces and each of the displays of a particular graphical user interface. Therefore, the GUI 138 can represent any graphical user interface, including but not limited to, a web browser, touch screen, or command line interface (CLI) that processes information in environment 100 and efficiently presents the information results to the user. In general, the GUI 138 may include a plurality of user interface (UI) elements, some or all associated with the client application 144, such as interactive fields, pull-down lists, and buttons operable by the user at client 135. These and other UI elements may be related to or represent the functions of the client application 144, as well as other software applications executing at the client 135. In particular, the GUI 138 may be used to present the client-based perspective of the hosted application 114, and may be used (as a web browser or using the client application 144 as a web browser) to view and navigate the hosted application 114, as well as various web pages located both internal and external to the server, some of which may be associated with the hosted application 114. The GUI 138 may be a part of or the entirety of the client application 144, while also merely a tool for displaying the visual representation of the client and hosted applications' 114 actions and interactions. In some instances, the GUI 138 and the client application 144 may be used interchangeably, particularly when the client application 144 represents a web browser associated with the hosted application 114.

While FIG. 1 is described as containing or being associated with a plurality of elements, not all elements illustrated within environment 100 of FIG. 1 may be utilized in each alternative implementation of the present disclosure. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

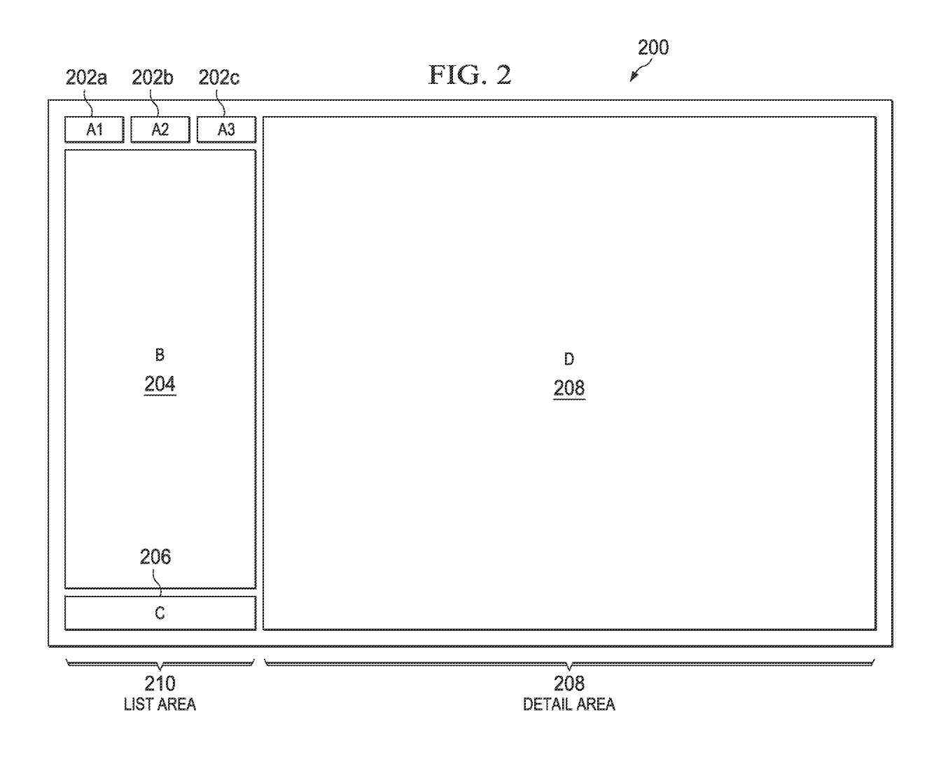

FIG. 2 is an schematic representation of the collection inspector 200. The schematic of the collection inspector 200 identifies four regions of the interface: A(1-3) 202a-c, B 204, C 206, and D 208. Region A(1-3) 202a-c may be buttons or other functions that are accessible by the user to execute a function through an interface (such as a mouse click or touch screen or other interface). Region A(1-3) 202a-c depicts triggers to toggle views in List Area 210, which can be used to open and close List Area 210. Region B 204 is a list that shows items in the collection. Region C 206 is an item to represent the collection itself. Region D 208 is a Detail Area, which displays the details of the item selected in the List Area.

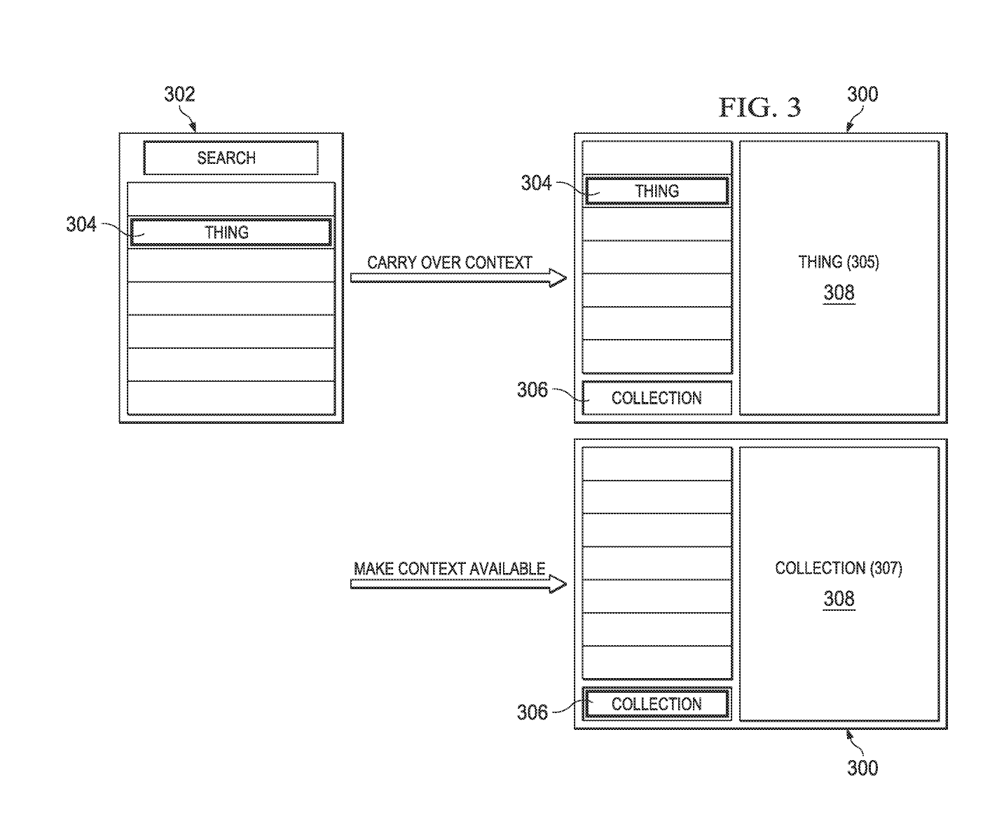

FIG. 3 is a schematic representation of an example implementation of the collection inspector 300 and a list of items from a search. In this example, a search is performed to establish a collection of items. Coming from a collection of items 302, this context (i.e., the search context) is carried over when the user inspects a single item 304. The user can inspect the single item 304, and can still navigate the context of the collection. The details 305 of the item 304 are shown in the Details Area 308. At the same time, the user is provided a handle 306 on the collection itself that allows the user to view, modify, and/or use this collection in a consistent way. The details 307 of the collection under inspection are shown in the Details Area 308.

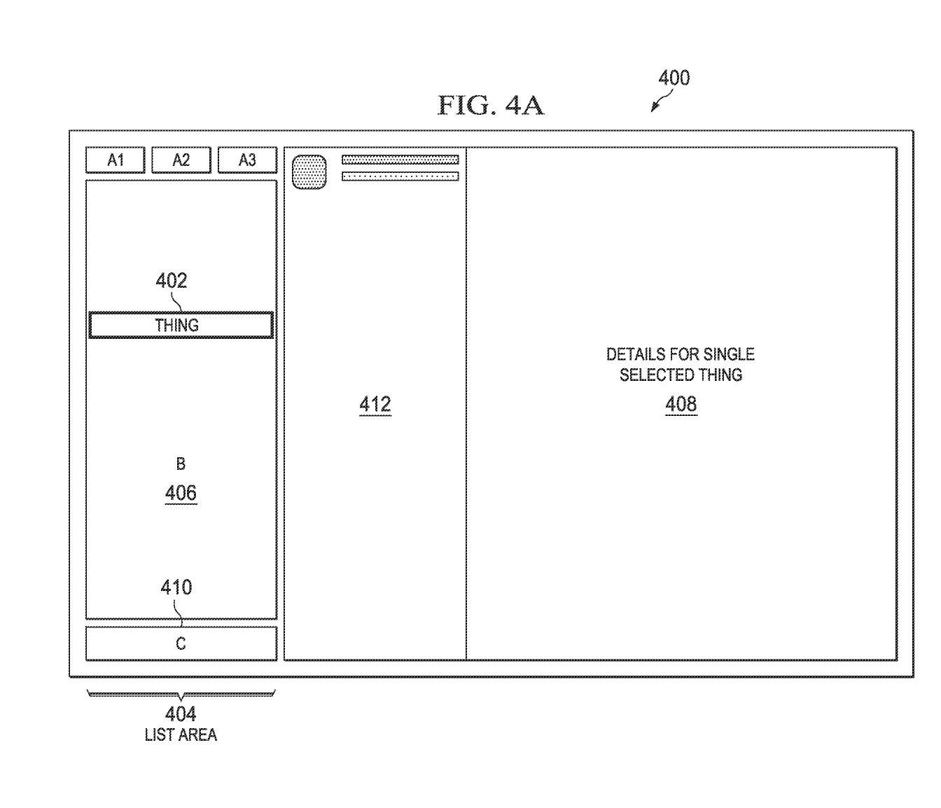

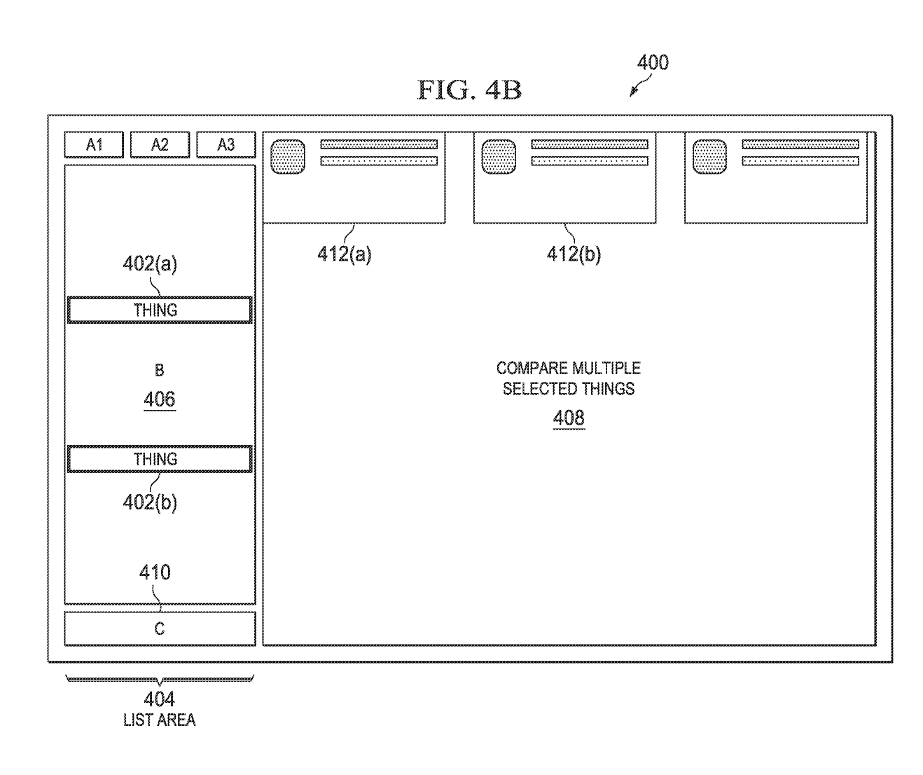

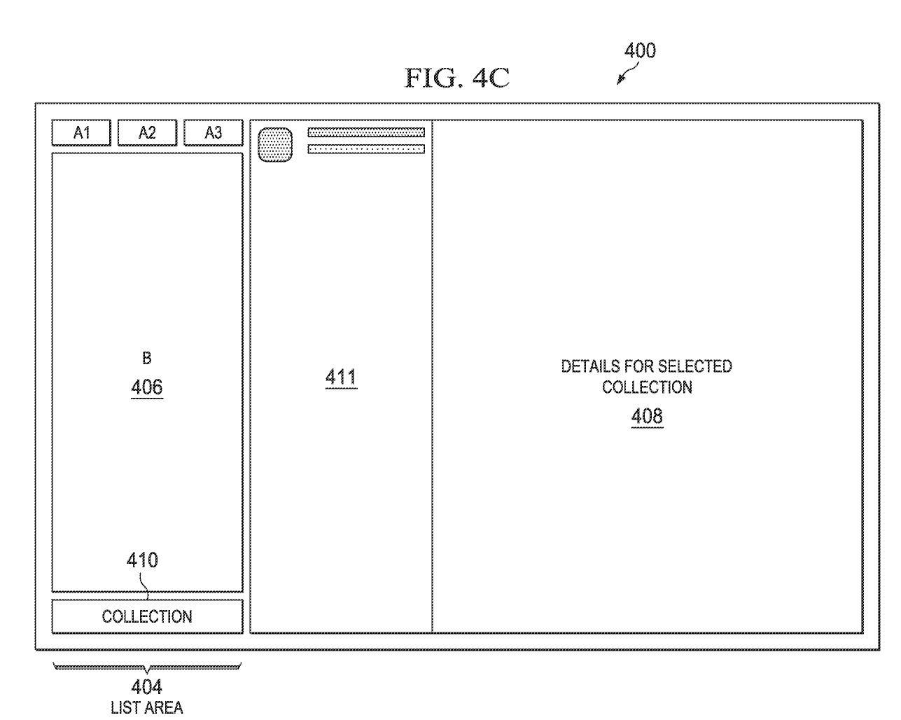

FIG. 4A is a schematic representation of an example implementation of the collection inspector 400 showing inspection of a single item 402. In FIG. 4A, the items 402 are displayed in the List Area 404, which permits the user to select an item from the collection list. The List Area 404 also displays a collection handle 410. The detail area 408 displays details of the selected item 412. FIG. 4B is a schematic representation of an example implementation of the collection inspector 400 showing inspection of multiple items. In FIG. 4B, the user selects multiple items 402(a) and 402(b) from the collection List Area 406. The Details Area 408 displays details 412(a) and 412(b) for multiple items for a comparison or for other functions or uses. FIG. 4C is a schematic representation of an example implementation of the collection inspector 400 showing inspection of the collection. The user selects the collection item 410 in the List Area 406. The Details Area 408 displays details 411 for the collection in the same way as for the individual items 402. The user can use the collection in the same way as with the individual items.

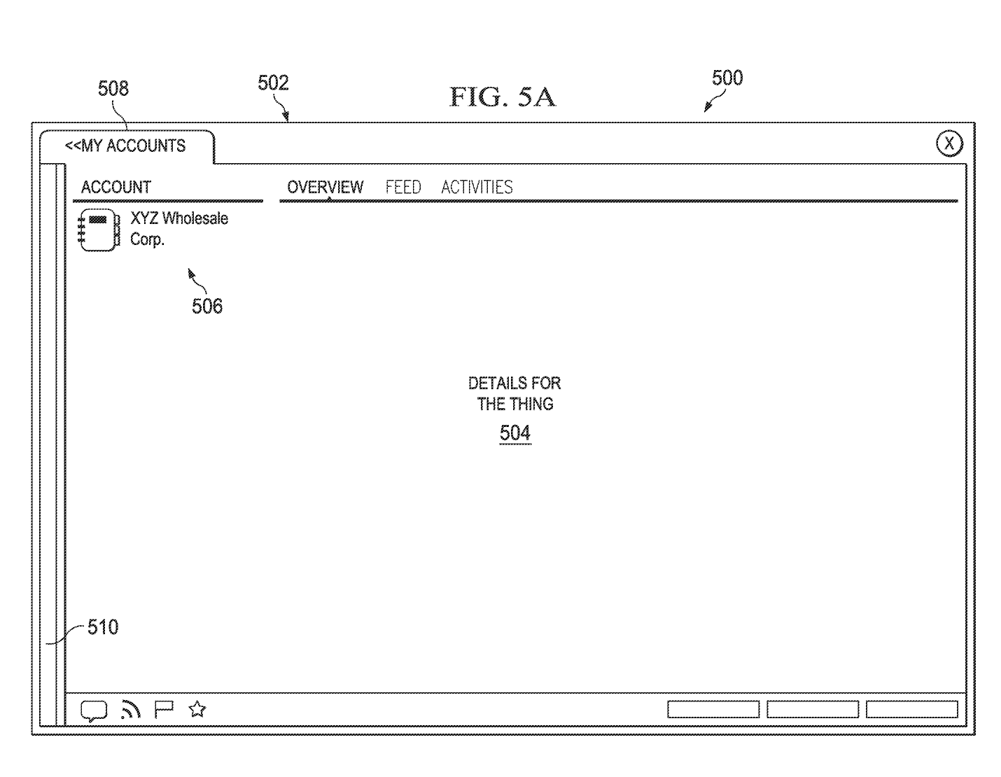

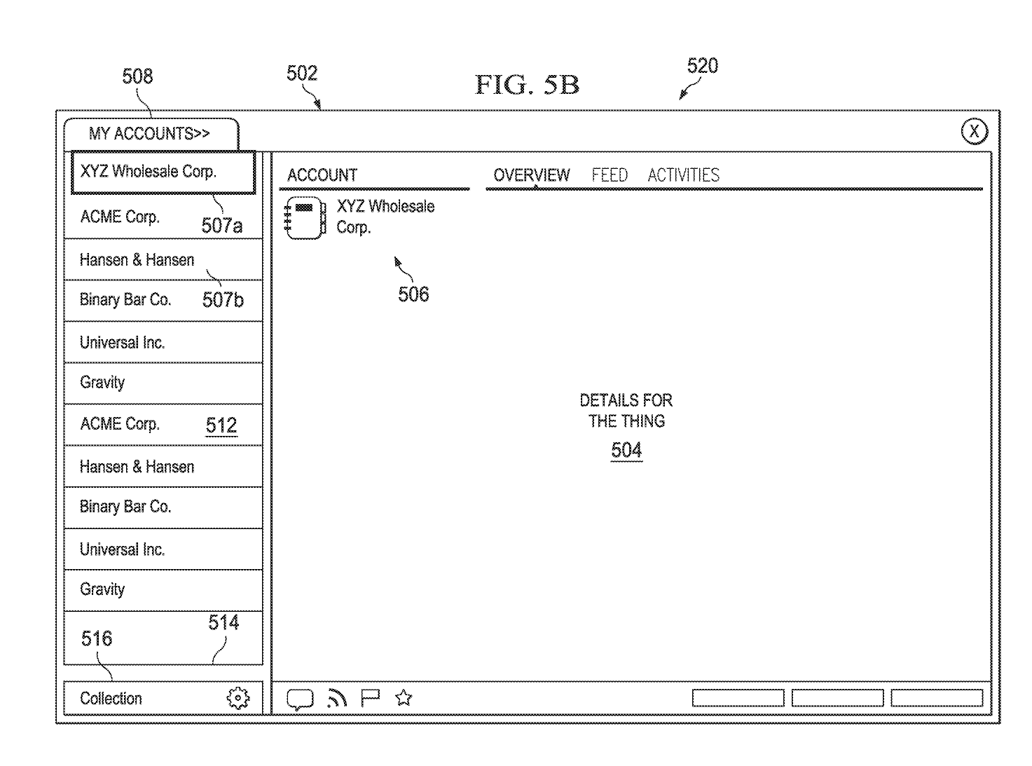

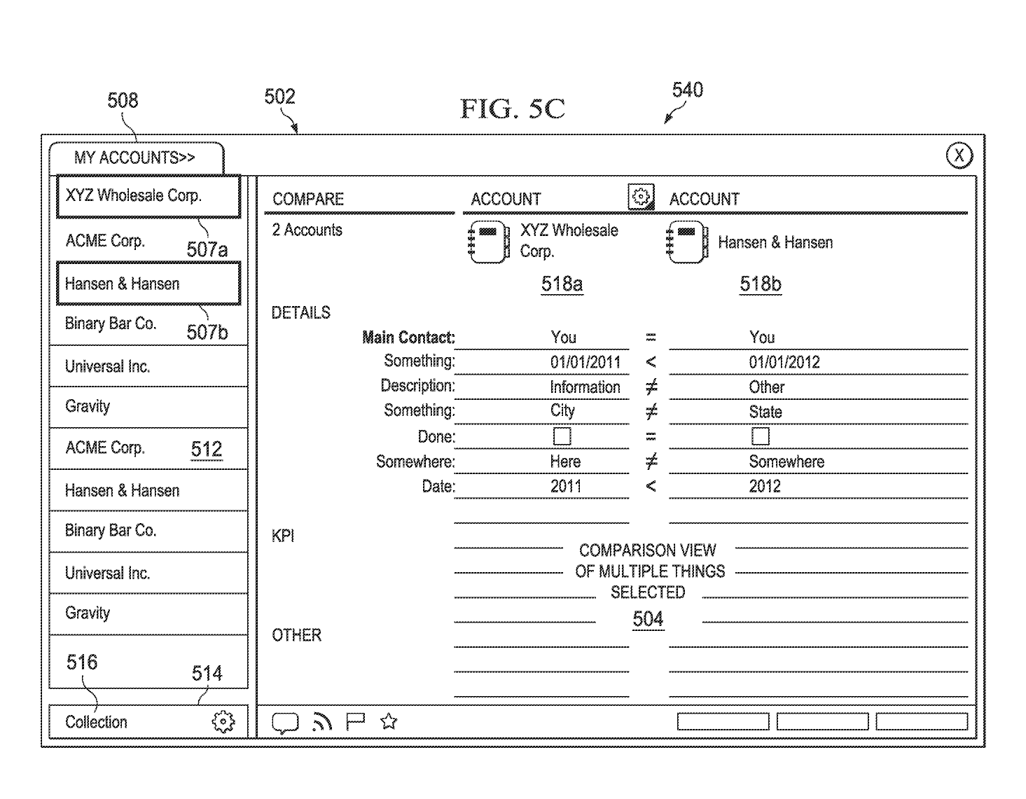

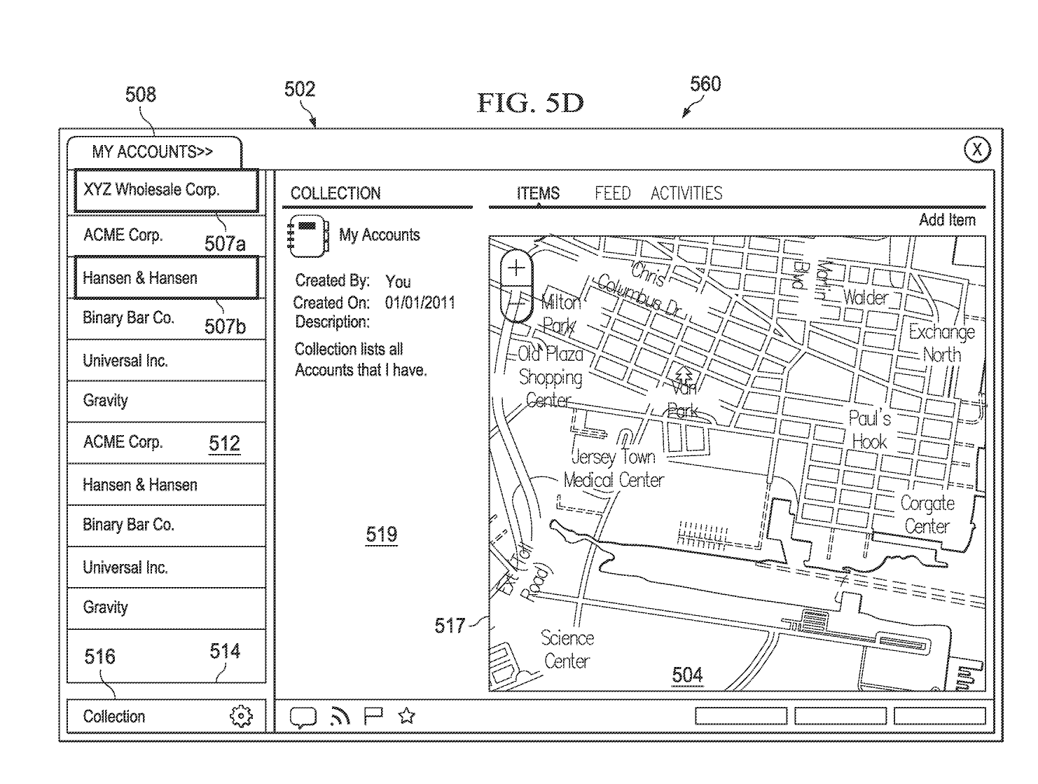

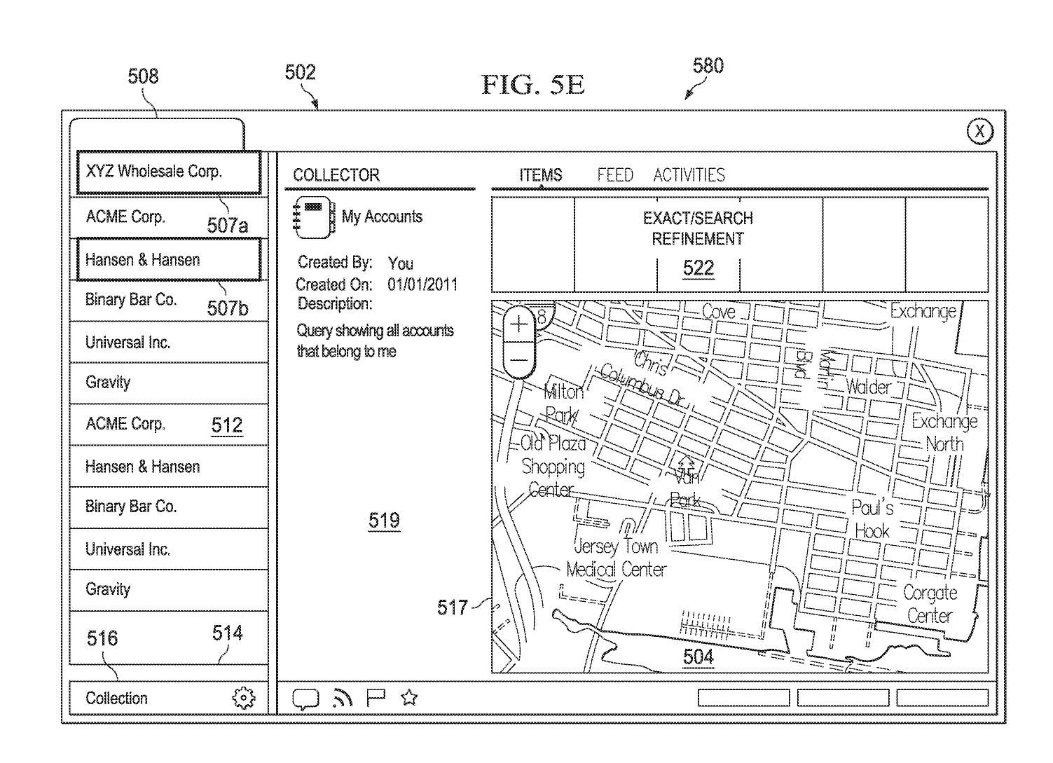

FIG. 5A is a screen shot 500 of an example implementation of the collection inspector 502. FIG. 5A shows a Details Area 504, where details for the item “XYZ Wholesale Corp.” 506 can be shown. In this screen shot 500, only the Details Area 504 is visible but the List Area can be opened by the user selecting the “My Accounts” tab 508. The interface may provide an indication 510 of the availability of a collection context.

FIG. 5B is a screen shot 520 of the example implementation of the collection inspector 502 of FIG. 5A. In this screen shot 520, the List Area 512 is opened. The List Area 512 shows a list 514 of items (e.g., item “XYZ Wholesale Corp.” 507a and “Hansen & Hansen” 507b) and the collection handle 516 for the collection context. One or more items 507a-b can be selected; the collection handle 516 may also be selected. Upon selection, the details of the item (or the collection) will be displayed in the Details Area 504. FIG. 5C is a screen shot 540 of the example implementation of the collection inspector 502 of FIG. 5A. In FIG. 5C, two items are selected: “XYZ Wholesale Corp.” 507a and “Hansen & Hansen” 507b, which are both items selected from the List Area 512. The Details Area 504 shows details 518a and 518b about each of the items selected, as well as other information.

FIG. 5D is a screen shot 560 of the example implementation of the collection inspector 502 of FIG. 5A showing the collection in the Details Area 504. The context handle 516 is selected and a collection item 519 is displayed in the Details Area 504. In this example, the collection detail 517 is a map showing location pins representing search results. The selection of the collection handle 516 can be performed in the same way as the items that form part of the collection. The Details Area 504 provides a visualization and handle for the collection 519. FIG. 5E is a screen shot 580 of the example implementation of the collection inspector 502 of FIG. 5A showing collection refinement input interface 522 in the Details Area 504. If the collection 519 is based on, e.g., a search, this search can be refined as part of the collection inspection. The refinement may be entered into a search area (i.e., input interface 522).

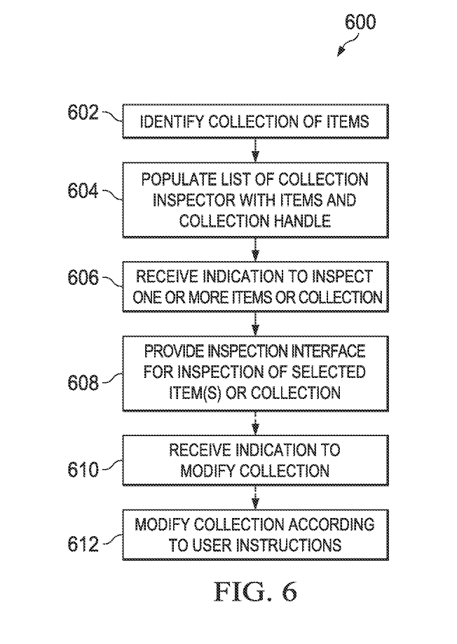

FIG. 6 is a process flow diagram 600 for providing an inspection of an item in the context of a collection. A collection of items can be identified (602). The collection can be identified by establishing the collection based on, e.g., a search or by other ways. The collection can also be identified from a previously saved collection. The items in the collection can populate a List Area of an interface, the interface used to perform an inspection of the item (604). The List Area provides a list of the items in the collection, as well as a handle for the collection itself. The handle can be thought of as an item representing the collection. The list of the items in the collection provides a context for the inspection of the items. The items and the collection handle are “selectable” for inspection by a user (e.g., by mouse click or other interface). An indication to inspect one or more items in the collection can be received (606). The indication can be, for example, the selection of one or more of the items on the list, or may be a selection of the collection handle. An inspection interface for inspection of the one or more items can be provided (608), the inspection interface providing at least data about the one or more items and a list of the items in the collection. The inspection interface can be a portion of the inspection program. For instances where a collection is selected for inspection, a user may modify or refine the collection. An indication may be received that the user wishes to modify or refine the collection (610). The indication may be in the form of a mouse click on a certain area or the selection of a command or other indication. The collection may be refined according to the user's instructions (612).

A number of embodiments of the invention have been described. Nevertheless, it will be understood that various modifications may be made without departing from the spirit and scope of the invention. For example, an item can be been opened out of a search result, the search result as well as the search itself can be available in one place. An item forms part of a history of items. The collection inspector can be used to make the history context available to the user. An item can have relations to other items based on several criteria. The collection inspector can allow the user to explore these relationships in one place. Other collection contexts can be displayed as well, based on the requirements of the individual applications. Accordingly, other embodiments are within the scope of the following claims. In addition, within the collection inspector the comparison of individual Things can be integrated in a consistent way by switching into a comparison view when more than one single item is selected.

1. A computer program product for providing a collection context, the computer program product comprising computer-readable instructions embodied on tangible, non-transient media and operable when executed to:
identify a collection of items;
receive an indication to inspect one or more items in the collection; and
provide an inspection interface for inspection of the one or more items in response to the received indication, the inspection interface including a list area and a detail area, the list area including a list of the items identified in the collection and a selectable handle for the collection, and the detail area configured to provide information pertaining to one or more items in the collection upon receiving an indication of the one or more items, and further configured to provide information pertaining to the collection upon selection of the selectable handle.

2-3. (canceled)

4. The computer program product of claim 1, wherein the indication to inspect one or more items in the collection includes receiving a selection of one or more items in the list of the items identified in the collection.

5. The computer program product of claim 1, wherein receiving the indication to inspect one or more items in the collection comprises receiving an indication to inspect two or more items in the collection, the computer program product further operable when executed to display details of the two or more items in the inspection interface, the display of the details of the two or more items facilitating a comparison of the details of the items.

6. The computer program product of claim 1, wherein the one or more items includes an item corresponding to the collection.

7. The computer program product of claim 1, wherein the list of the items identified in the collection provides a context for the inspection of the items.

8. The computer program product of claim 1, wherein the items include user-centric projections of business objects.

9. The computer program product of claim 1, wherein the collection is a collection of user-centric projections of business objects.

10. A computer-implemented method for providing a collection context comprises:
identifying a collection of items;
receiving an indication to inspect one or more items in the collection; and
providing an inspection interface for inspection of the one or more items in response to the received indication, the inspection interface including a list area and a detail area, the list area including a list of the items identified in the collection and a selectable handle for the collection, and the detail area configured to provide information pertaining to one or more items in the collection upon receiving an indication of the one or more items, and further configured to provide information pertaining to the collection upon selection of the selectable handle.

11-12. (canceled)

13. The method of claim 10, wherein the indication to inspect one or more items in the collection includes receiving a selection of one or more items in the list of the items identified in the collection.

14. The method of claim 10, wherein receiving the indication to inspect one or more items in the collection comprises receiving an indication to inspect two or more items in the collection, the method further comprising displaying details of the two or more items in the inspection interface, the display of the details of the two or more items facilitating a comparison of the details of the items.

15. The method of claim 10, wherein the one or more items includes an item corresponding to the collection.

16. The method of claim 10, wherein the list of the items identified in the collection provides a context for the inspection of the items.

17. The method of claim 10, wherein the items include user-centric projections of business objects.

18. The method of claim 10, wherein the collection is a collection of user-centric projections of business objects.
